(19) United States
(12) Patent Application Publication
(10) Pub. No.: US 2021/0193069 A1
(43) Pub. Date: Jun. 24, 2021

(54) ARRAY SUBSTRATE AND METHOD FOR DRIVING SAME, DISPLAY MODULE, AND DISPLAY DEVICE

(71) Applicants: Beijing BOE Optoelectronics Technology Co., Ltd., Beijing (CN); BOE Technology Group Co., Ltd., Beijing (CN)

(72) Inventors: Shuo Li, Beijing (CN); Guangquan Wang, Beijing (CN); Chao Tian, Beijing (CN); Xiang Yuan, Beijing (CN); Qingqing Ma, Beijing (CN); Yinan Gao, Beijing (CN); Tianjiao Wang, Beijing (CN); Yin Yuan, Beijing (CN); Junpeng Han, Beijing (CN); Guojie Qin, Beijing (CN)

(73) Assignees: Beijing BOE Optoelectronics Technology Co., Ltd.; BOE Technology Group Co., Ltd.

(21) Appl. No.: 16/918,092

(22) Filed: Jul. 1, 2020

(30) Foreign Application Priority Data
Dec. 18, 2019 (CN) 201911308663.9

(51) Int. Cl. G09G 3/36

(52) U.S. Cl. CPC G09G 3/3677; G09G 2310/0213; G09G 3/3688

(57) ABSTRACT

Disclosed are an array substrate and a method for driving the same, a display module, and a display device. The array substrate includes a plurality of data lines, a plurality of first gate lines, a plurality of second gate lines, a plurality of pixels and a plurality of switch circuit. Each of the first gate lines is connected to the plurality of switch circuit disposed in at least one region, and each of the switch circuit is connected to a row of pixels in the region where the switch circuit is disposed, and each of the second gate lines is connected to a plurality of rows of pixels disposed in different regions.

This application claims priority to Chinese Patent Application No. 201911308663.9, filed before the National Intellectual Property Administration, PRC on Wednesday, Dec. 18, 2019 and entitled “ARRAY SUBSTRATE AND DRIVING METHOD FOR DRIVE SAME, DISPLAY MODULE, AND DISPLAY DEVICE”, the entire contents of which are incorporated herein by reference.

### TECHNICAL FIELD

The present disclosure relates to the technical field of display, more particularly, relates to an array substrate and a method for driving the same, a display module, and a display device.

### BACKGROUND

Liquid crystal display (LCD) devices are widely used in the display field due to their small size, low power consumption, and less radiation.

In the related art, the array substrate in the LCD device is generally provided with a plurality of gate lines extending in a first direction, and a plurality of data lines extending in a second direction, and the first direction is perpendicular to the second direction. Each of the gate lines is connected to a row of pixels for providing a gate drive signal for the row of pixels, and each of the data lines is connected to a column of pixels for providing a data signal for the column of pixels.

### SUMMARY

Embodiments of the present disclosure provide an array substrate and a method for the same, a display module, and a display device. The technical solutions are described as follows.

In one aspect, an array substrate is provided. The array substrate is provided with a plurality of regions, and includes a plurality of data lines, a plurality of first gate lines, a plurality of second gate lines, and a plurality of pixels, and a plurality of switch circuit that are disposed in each of the regions, at least one row of the pixels and at least one of the switch circuit being arranged in each of the regions; wherein

each of the first gate lines is connected to the plurality of switch circuit disposed in at least one of the regions, and each of the first gate lines is configured to provide a first gate drive signal for the switch circuit connected thereto;

each of the data lines is connected to the plurality of switch circuit disposed in the same column, and each of the data lines is configured to provide a data signal for the switch circuit connected thereto;

each of the switch circuit is further connected to a column of pixels in the region where the switch circuit is disposed, and each of the switch circuit is configured to output the data signal to a column of pixels connected thereto in response to the first gate drive signal; a

each of the second gate lines is connected to a plurality of rows of the pixels, and at least two rows of the pixels connected to each of the second gate lines are disposed in different regions, and each of the second gate lines is configured to provide a second gate drive signal for the plurality of rows of the pixels connected thereto.

Optionally, each of the first gate lines is connected to a plurality of the switch circuit of one of the regions, and the switch circuit connected to each of the first gate lines are disposed in different regions.

Optionally, a plurality of rows of the pixels connected to each of the second gate lines are disposed in different regions.

Optionally, the array substrate includes n second gate lines, and n rows of the pixels are arranged in each of the regions;

an i^{th} second gate lines is connected to an i^{th} row of the pixels of each of the regions, n being a positive integer greater than 1, and i being a positive integer less than or equal to n.

Optionally, the number of switch circuit arranged in each of the regions is equal to the number of columns of the pixels arranged in the region, and the pixels connected to different switch circuit in each of the regions are disposed in different columns.

Optionally, each of the pixels includes a drive transistor and a light emitting element, and each of the switch circuit includes a switch transistor; wherein

a gate of the switch transistor is connected to the first gate line, a first electrode of the switch transistor is connected to the data line, and a second electrode of the switch transistor is connected to a first electrode of the drive transistor;

a gate of the drive transistor is connected to the second gate line, and a second electrode of the drive transistor is connected to the light emitting element.

Optionally, each of the switch circuit is disposed in a non-display zone of one of the pixels, or each of the switch circuit is disposed in a region between two adjacent pixels.

Optionally, each of the first gate lines includes a first sub-line segment and a second sub-line segment connected to the first sub-line segment, and the first sub-line segment is connected to the plurality of switch circuit; each of the second gate lines includes a plurality of third sub-line segments and a fourth sub-line segment connected to each of the third sub-line segments, and each of the third sub-line segments is connected to one row of the pixels;

wherein each first sub-line segment is parallel to each of the third sub-line segment, each second sub-line segment is parallel to each fourth sub-line segment, and an extending direction of each first sub-line segments intersects with an extending direction of any second sub-line segment.

Optionally, each first sub-line segment and each of the third sub-line segments are perpendicular to an extending direction of the data line, and each second sub-line segment and each fourth sub-line segment are parallel to the extending direction of the data line.

Optionally, the array substrate is provided with k regions, and the array substrate includes k first gate lines, k being a positive integer greater than 1; the number of switch circuit arranged in each of the regions is equal to the number of columns of the pixels arranged in the region, the pixels connected to different switch circuit in each of the regions are disposed in different columns, and each of the switch circuit is disposed in a non-display zone of one of the pixels;

each of the first gate lines is connected to a plurality of the switch circuit of one region, and the switch circuit connected to each of the first gate lines are disposed in different regions;

each of the pixels includes a drive transistor and a light emitting element, and the switch circuit include a switch transistor;

a gate of the switch transistor is connected to the first gate line, a first electrode of the switch transistor is connected to the data line, and a second electrode of the switch transistor is connected to a first electrode of the drive transistor;

a gate of the drive transistor is connected to the second gate line, and a second electrode of the drive transistor is connected to the light emitting element.

In another aspect, a method for driving an array substrate is provided, The method is applicable to the array substrate as described above, and includes:

a signal writing phase: providing the first gate drive signal sequentially for a plurality of first gate lines, providing the data signal for each of the data lines, and providing the second gate drive signal sequentially for a plurality of second gate lines, the switch circuit outputting the data signal to a column of pixels connected thereto in response to the first gate drive signal;

wherein within a duration of providing the first gate drive signal for each of the first gate lines, the second gate drive signal is provided sequentially for the plurality of second gate lines.

Optionally, after the signal writing phase, the method further includes:

a first retention phase: alternatively providing the second gate drive signal at a first potential and a signal at a second potential for each of the second gate lines, and stopping providing the first gate drive signal for each of the first gate lines.

Optionally, after the signal writing phase, the method further includes:

a second retention phase: alternatively providing the first gate drive signal at the first potential and the signal at the second potential for each of the first gate lines, and stopping providing the second gate drive signal for each of the second gate lines.

In still another aspect, a display module is provided. The display module includes a gate drive circuit, a source drive circuit, and an array substrate as described above; wherein

the gate drive circuit is connected to the first gate lines and the second gate lines in the array substrate, and the gate drive circuit is configured to provide the first gate drive signal for the first gate lines and provide the second gate drive signal for the second gate lines;

the source drive circuit is connected to the data lines in the array substrate, and the source drive circuit is configured to provide the date signal for the data line.

Optionally, the gate drive circuit includes a first gate drive chip and a second gate drive chip;

the first gate drive chip is connected to the first gate line, for providing the first gate drive signal for the first gate line; and

the second gate drive chip is connected to the second gate line, for providing the second gate drive signal for the second gate line.

In a further aspect, a display device is provided. The display device includes the display module as described above and a housing configured to package the display module.

### BRIEF DESCRIPTION OF THE DRAWINGS

For clearer descriptions of the technical solutions of the embodiments of the present disclosure, the accompanying drawings required to describe the embodiments are briefly described below. Apparently, the accompanying drawings described below are only some embodiments of the present disclosure. Those of ordinary skill in the art may further obtain other accompanying drawings based on these accompanying drawings without inventive effort.

FIG. 1 is a schematic structural diagram of an array substrate in the related art;

FIG. 2 is a schematic structural diagram of an array substrate according to an embodiment of the present disclosure;

FIG. 3 is a schematic structural diagram of another array substrate according to an embodiment of the present disclosure;

FIG. 4 is a schematic structural diagram of still another array substrate according to an embodiment of the present disclosure;

FIG. 5 is a flowchart of a driving method for an array substrate according to an embodiment of the present disclosure;

FIG. 6 is a timing diagram of each signal line of an array substrate according to an embodiment of the present disclosure;

FIG. 7 is a timing diagram of each signal line of another array substrate according to an embodiment of the present disclosure; and

FIG. 8 is a schematic structural diagram of a display module according to an embodiment of the present disclosure.

### DETAILED DESCRIPTION

For clearer descriptions of the objectives, technical solutions, and advantages of the present disclosure, the present disclosure is described below in detail with reference to the accompanying drawings.

Transistors adopted in the embodiment of the present disclosure may be thin film transistors or field-effect transistors or other devices with the same characteristics, and the transistors adopted in the embodiment of the present disclosure are mainly switch transistors according to the effect in the circuit. Sources and drains of the switch transistors adopted herein are symmetrical, and thus the sources and the drains may be interchanged. In the embodiments of the present disclosure, the source is called a first electrode and the drain is called a second electrode, or the drain is called a first electrode and the source is called a second electrode. According to the forms in the accompanying drawings, the intermediate end of the transistor is a gate, the signal input end is a source, and the signal output end is a drain. In addition, the switch transistor employed in the embodiments of the present disclosure may be any one of a P-type switch transistor and an N-type switch transistor, wherein the P-type switch transistor is turned on when the gate is at a low potential and is turned off when the gate is at a high potential, and the N-type switch transistor is turned on when the gate is at a high potential and is turned off when the gate is at a low potential.

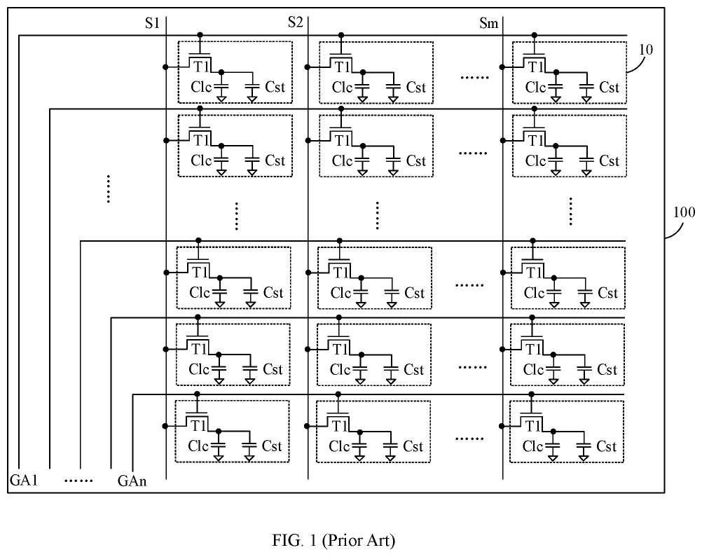

FIG. 1 is a schematic structural diagram of an array substrate in the related art. With reference to FIG. 1, the array substrate 100 includes n rows and m columns of pixels 10 arranged in an array. Correspondingly, in order to scan the n rows of pixels 10 row by row, the array substrate 100 may include a total of n gate lines GA1 to GAn, and a total of m data lines S1 to Sm.

Each of the gate lines GA may be connected to a row of pixels 10, and the pixels 10 connected to each of the gate lines GA are disposed in different rows; the gate lines GA may be used to provide a gate drive signal for a row of pixels 10 connected thereto. Each of the data lines S may be connected to a column of pixels 10, and the pixels 10 connected to each of the data lines GA are disposed in different columns; and the data lines GA may be used to provide a data signal for a column of pixels 10 connected thereto. The pixels 10 may emit light under the drive of the gate drive signal and the data signal.

For example, with reference to FIG. 1, the first to n^{th} gate lines GA1 to GAn may be sequentially connected to the first row of pixels 10 to the n^{th} row of pixels 10, and the first to m^{th} data lines S1 to Sm may be sequentially connected to the first column of pixels 10 to the m^{th} column of pixels 10. Further, with reference to FIG. 1, taking the array substrate 100 being a liquid crystal display substrate as an example, each pixel 10 may include a drive transistor T1, and a pixel electrode connected to the drive transistor T1, a common electrode, and liquid crystal molecules between the pixel electrode and the common electrode. With reference to FIG. 1, the pixel electrode and the common electrode may be equivalent to a liquid crystal capacitor Clc, and a storage capacitor Cst may be formed between the pixel electrode and the common electrode. For each of the drive transistors T1, a gate may be connected to the gate line GA, a first electrode may be connected to the data line S, and a second electrode may be connected to the pixel electrode. Each of the drive transistors T1 may output the data signal to the pixel electrode connected thereto in response to the gate drive signal provided by the gate line GA to drive the liquid crystal molecules to deflect, thereby causing the pixels 10 to emit light.

However, in combination with FIG. 1, since one gate line is required for each row of the pixels in the array substrate of the related art, the number of gate lines required to be arranged on the array substrate will be large and the wiring space occupied is large when the resolution of the display device is high, which may not facilitate the narrow-bezel design.

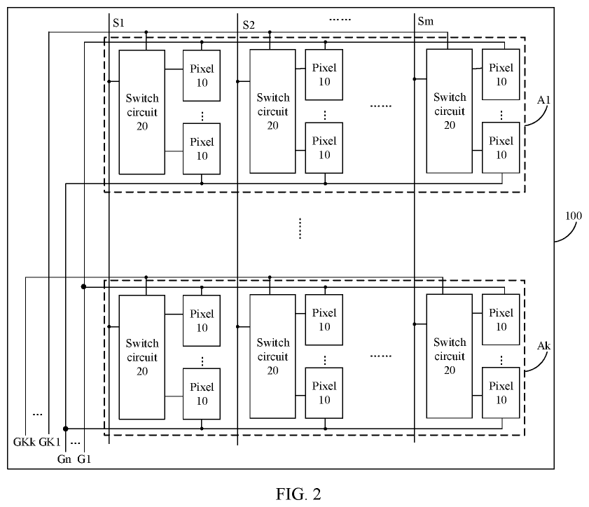

An embodiment of the present disclosure provides an array substrate, the plurality of rows of pixels may be scanned reliably row by row under the premise that the number of gate lines required to arrange in the array substrate is reduced effectively, thereby facilitating the narrow-bezel design. FIG. 2 is a schematic structural diagram of an array substrate according to an embodiment of the present disclosure; As shown in FIG. 2, the array substrate 100 is provided with a plurality of regions A. The array substrate 100 may include a plurality of data lines S, a plurality of first gate lines GK, a plurality of second gate lines G, a plurality of pixels 10 and a plurality of switch circuit 20 that are disposed in each of the regions A. At least one row of the pixels 10 and at least one switch circuit 20 are arranged in each of the regions A.

For example, with reference to FIG. 2, the array substrate 100 illustrated is provided with a total of k regions A1 to Ak; the array substrate 100 illustrated includes a total of m data lines S1 to Sm, a total of k first gate lines GK1 to GKk, a total of n second gate lines G1 to Gn, n rows and m columns of pixels 10 disposed in each of the regions A and arranged in an array, and m switch circuit 20 disposed in each of the regions A. Optionally, the number of rows of the pixels in different regions A may not be equal. Here, k, m and n are integers greater than 1.

Each of the first gate lines GK may be connected to the plurality of switch circuit 20 disposed in at least one of the regions A. Each of the first gate lines GK may provide a first gate drive signal for the switch circuit 20 connected thereto.

Each of the data lines S may be connected to the plurality of switch circuit 20 disposed in the same column. Each of the data lines S may provide a data signal for the switch circuit 20 connected thereto.

Each of the switch circuit 20 may further be connected to a column of pixels 10 of the region A where the switch circuit is disposed. Each of the switch circuit 20 may output the data signal to a column of pixels 10 connected thereto in response to the first gate drive signal.

For example, each of the switch circuit 20 may output the data signal provided by the data line S to a column of pixels 10 connected thereto when the first gate line GK provides the first gate drive signal for the switch circuit.

Each of the second gate lines G may be connected to a plurality of rows of pixels 10, and at least two rows of pixels 10 connected to each of the second gate lines G are disposed in different regions A. Each of the second gate lines G may provide a second gate drive signal for the plurality of rows of pixels 10 connected thereto.

For example, each of the pixels 10 may emit light when the second gate lines G provide the second gate drive signal for the pixel and the switch circuit 20 output the data signal to the pixel in response to the first gate drive signal.

In summary, the embodiment of the present disclosure provides an array substrate, wherein since in the array substrate each of the first gate lines is connected to the plurality of switch circuit in at least one region and each of the switch circuit is connected to a row of pixels in the region where each of the switch circuit is disposed, each of the switch circuit may output the data signal to a column of pixels connected thereto in response to the gate drive signal provided by the first gate line; in this way, one of the second gate lines may be arranged to be connected to a plurality of rows of pixels disposed in different regions. Compared with a situation in which one gate line is arranged for each row of pixels in the related art, the method according to the embodiment of the present disclosure may ensure the reliable row-by-row scanning of the plurality of rows of pixels by flexibly controlling the signals provided by the signal lines. In other words, under the premise of ensuring reliability in driving, the number of gate lines required to be arranged is effectively reduced, which facilitates the narrow-bezel design.

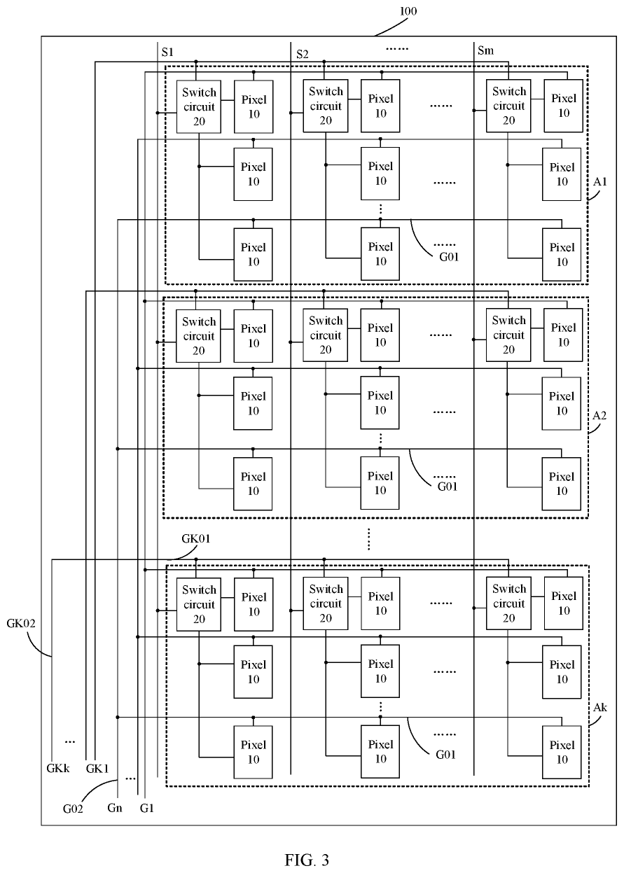

FIG. 3 is a schematic structural diagram of another array substrate according to an embodiment of the present disclosure. As shown in FIG. 3, each of the first gate lines GK may be connected to the plurality of switch circuit 20 disposed in at least one of the regions A, and the switch circuit 20 connected to each of the first gate lines GK are disposed in different regions A.

For example, with reference to FIG. 3, the array substrate 100 is provided with a total of k regions A1 to Ak, wherein k is a positive integer greater than 1. Correspondingly, the array substrate 100 may include a total of k first gate lines GK1 to GKk. The 1^{st} first gate line GK1 may be connected to a plurality of switch circuit 20 disposed in the first region A1, and the 2^{nd} first gate line GK2 may be connected to a plurality of switch circuit 20 disposed in the second region A2; in this analogy, the k^{th} first gate line GKk may be connected to the plurality of switch circuit 20 disposed in the k^{th} region Ak.

By arranging each of the first gate lines GK to be only connected to the plurality of switch circuit 20 disposed in one region A, each of the first gate lines GK may independently control the working state of the plurality of pixels 10 disposed in one region A. In addition, by arranging each of the first gate lines GK to be connected to the plurality of switch circuit 20 disposed in different regions A, the flexible control of the drive signal provided by each of the first gate lines GK may realize sequential scanning for each of the regions, so as to ensure the display effect. For example, when the first gate drive signal is sequentially provided for the k first gate lines GK1 to GKk, the switch circuit 20 disposed in the k regions A are turned on sequentially, such that the plurality of pixels disposed in the k regions A emit light sequentially.

Optionally, with reference to FIG. 3, each row of the pixels 10 connected to each of the second gate lines G may be disposed in different regions A. In other words, each of the second gate lines G may be connected to the plurality of rows of pixels 10 disposed in different regions A. And, the pixels 10 connected to each of the second gate lines G are disposed in different rows. For example, assuming that each of the second gate lines G is connected to a total of 100 rows of pixels 10, the 100 rows of pixels 10 may all be disposed in different regions A.

By arranging each of the first gate lines Gk to be connected to the plurality of switch circuit 20 disposed in one region A and each of the second gate lines G to be connected to the plurality of rows of pixels 10 disposed in different regions A, the plurality of rows of pixels in the same region A may be prevented from emitting light at the same time by flexibly adjusting the second gate drive signal provided by the second gate line G, thereby further ensuring the display effect.

Optionally, with reference to FIG. 3, the array substrate 100 may include n second gate lines G1 to Gn, and each of the regions A may include n rows of pixels 10. The i^{th} second gate lines Gi may be connected to the i^{th} row of the pixels 10 of each of the regions A, wherein n is a positive integer greater than 1, and i is a positive integer less than or equal to n. In other words, the number of rows of pixels between every two adjacent rows of pixels 10 connected to each of the second gate lines G is a fixed value n−1, i.e., each two adjacent rows of pixels 10 connected to each of the second gate lines G are separated by n−1 rows of pixels.

For example, with reference to FIG. 3, when the i is equal to 1, the first second gate line G1 may be connected to the first row of pixels 10 in each of the regions A, respectively. When the i is equal to 2, the 2^{nd} second gate line G2 may be connected to the second row of pixels 10 in each of the regions A, respectively. In this analogy, when the i is equal to n, the n^{th} second gate line Gn may be connected to the n^{th} row of pixels 10 in each of the regions A, respectively.

By arranging the i^{th} second gate line G to be connected to the i^{th} row pixel 10 of each of the regions A, the arrangement of the second gate lines is facilitated, and the plurality of rows of pixels 10 disposed in each of the regions A emit light sequentially in an extending direction of the data line S when the gate drive signal is sequentially provided for the plurality of the second gate lines G, thereby further ensuring the display effect of the array substrate.

In the embodiment of the present disclosure, with reference to FIGS. 2 and 3, the number of switch circuit 20 arranged in each of the regions A may be equal to the number of columns of pixels 10 arranged in the region A, and the pixels 10 connected to different switch circuit 20 in each of the regions A are disposed in different columns. In other words, each of the switch circuit 20 is connected to only one column of pixels 10 in one region A, and different switch circuit 20 are connected to different columns of pixels 10. Thus, independent control for the columns of pixels 10 in each of the regions 10 may be realized.

For example, as shown in FIGS. 2 and 3, m switch circuit 20 and m columns of pixels 10 are arranged in each of the regions A of the array substrate 100, and each of the switch circuits 20 is connected to a column of pixels 10.

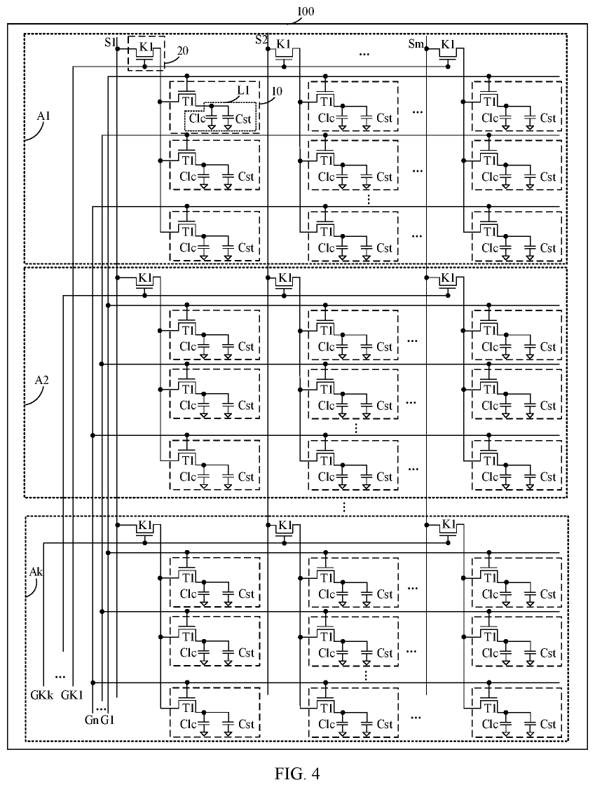

Optionally, FIG. 4 is a schematic structural diagram of another array substrate according to an embodiment of the present disclosure. As shown in FIG. 4, each of the pixels 10 may include a drive transistor T1 and a light emitting element L1, and each of the switch circuits 20 may include a switch transistor K1.

In combination with FIGS. 3 and 4, a gate of the switch transistor K1 may be connected to the first gate lines GK, a first electrode of the switch transistor K1 may be connected to the data lines S, and a second electrode of the switch transistor K1 may be connected to a first electrode of the drive transistor T1.

A gate of the drive transistor T1 may be connected to the second gate lines G, and a second electrode of the drive transistor T1 may be connected to the light emitting element L1.

Optionally, the array substrate 100 may be an array substrate of an LCD display device or an array substrate of an organic light-emitting diode (OLED) display device.

With reference to FIG. 4, when the array substrate is an array substrate of an LCD display device, the light emitting element L1 may include a pixel electrode, a common electrode, and liquid crystal molecules between the pixel electrode and the common electrode. With reference to FIG. 4, the pixel electrode and the common electrode may be equivalent to a liquid crystal capacitor Clc, and a storage capacitor Cst may be formed between the pixel electrode and the common electrode. The second electrode of the drive transistor T1 may be connected to the pixel electrode of the light emitting element L1. Optionally, in combination with FIGS. 3 and 4, the array substrate 100 illustrated includes m data lines Si to Sm.

Optionally, each of the switch circuits 20 may be disposed in a non-display zone of one pixel 10, or each of the switch circuits 20 may be disposed in a region between two adjacent pixels 10. In other words, each of the switch transistors K1 connected to the first gate lines GK may be laid out within the pixel 10, or may be laid out outside the pixel 10 as needed. In addition, the drive transistor T1 connected to the second gate lines G may be laid out in the pixel 10.

Optionally, in combination with FIGS. 3 and 4, each of the first gate lines GK may include a first sub-line segment GK01 and a second sub-line segment GK02 connected to the first sub-line segment GK0L wherein the first sub-line segment GK01 is connected to a plurality of switch circuit 20 in one region A. Each of the second gate lines G may include a plurality of third sub-line segments G01, and a fourth sub-line segment G02 connected to each of the third sub-line segments G01, wherein each of the third sub-line segments G01 is connected to a row of pixels 10.

Each first sub-line segment GK01 and each of the third sub-line segments G01 may be parallel to each other. Each second sub-line segment GK02 and each fourth sub-line segment G02 may be parallel to each other, and an extending direction of each first sub-line segment GK01 intersects with an extending direction of any second sub-line segment GK02.

For example, each first sub-line segment GK01 and each of the third sub-line segments G01 may be perpendicular to an extending direction of the data line S, and each second sub-line segment GK02 and each fourth sub-line segment G02 may be parallel to an extending direction of the data line S. In other words, the two sub-line segments included in each of the first gate lines GK may be perpendicular to each other, and the third and fourth sub-line segments G01 and G02 included in each of the second gate lines G may also be perpendicular to each other.

Correspondingly, assuming that the array substrate 100 has k regions and each of the regions k includes n rows of pixels, the array substrate in the related art requires k*n gate lines to drive the plurality of rows of pixels 10 in the array substrate 100 when k is greater than 1 and n is greater than 2 by comparing FIG. 1, FIG. 3 with FIG. 4. Correspondingly, in the related art, a portion of (k*n) gate lines need to be arranged in the fan-out region of the peripheral wiring of the array substrate 100. The array substrate according to the embodiment of the present disclosure only requires (k+n) gate lines to achieve reliable scanning of the plurality of rows of pixels 10 in the array substrate 100. Correspondingly, only a portion of (k+n) gate lines should be arranged in the fan-out region of the peripheral wiring of the array substrate 100 according to the embodiment of the present disclosure. In other words, the embodiment of the present disclosure provides fewer signal lines in the fan-out region of the peripheral wiring of the array substrate, which facilitates the narrow-bezel design.

In summary, the embodiment of the present disclosure provides an array substrate, wherein since in the array substrate each of the first gate lines is connected to the plurality of switch circuits in at least one region and each of the switch circuits is connected to a row of pixels in a region where each of the switch circuits is disposed, each of the switch circuits may output the data signal to a column of pixels connected thereto in response to the gate drive signal provided by the first gate line, such that one of the second gate lines may be arranged to be connected to a plurality of rows of pixels disposed in different regions. Compared with a situation in which one gate line is arranged for each row of pixels in the related art, the method according to the embodiments of the present disclosure may ensure the reliable row-by-row scanning of the plurality of rows of pixels by flexibly controlling the signals provided by the signal lines. In other words, under the premise of ensuring reliability in driving, the number of gate lines required to be arranged is effectively reduced, which facilitates the narrow-bezel design.

FIG. 5 is a flow chart of a method for driving an array substrate according to an embodiment of the present disclosure, which may be applied to the array substrate shown in any one of FIG. 2 to FIG. 4. As shown in FIG. 5, the method may include:

Step 501, a signal writing phase, in which a first gate drive signal is provided sequentially for the plurality of first gate lines, a data signal is provided for each of the data lines, a second gate drive signal is provided sequentially for the plurality of second gate lines, and the switch circuits output the data signal to a column of pixels connected thereto in response to the first gate drive signal.

Within a duration of providing the first gate drive signal for each of the first gate lines, the second gate drive signal is provided sequentially for the plurality of second gate lines.

In summary, the embodiment of the present disclosure provides a method for driving an array substrate. Since the switch circuits may output the data signal to a column of pixels connected thereto in response to the gate drive signal provided by the first gate line, only one of the second gate lines may be arranged to connect to the plurality of rows of pixels in different regions for using the driving method to flexibly control the signals provided by each of the signal lines, thereby ensuring the reliable row-by-row scanning for the plurality of rows of pixels. Thus, under the premise of ensuring reliability in driving, the number of gate lines required to be arranged is effectively reduced, which facilitates the narrow-bezel design.

Optionally, with reference to FIG. 5, after the signal writing phase, i.e., after the above step S501, the method may further include:

Step 502, a first retention phase, in which a second gate drive signal at a first potential and a signal at a second potential are alternatively provided for each of the second gate lines, and providing the first gate drive signal for each of the first gate lines is stopped.

Correspondingly, in the first retention phase, the drive transistor connected to each of the second gate lines may be turned on and off alternately, and the switch transistors connected to the plurality of first gate lines may remain off. By the first retention phase, the problem that the drive transistor maintains negative or positive voltage for a long time and the characteristic drift occurs may be avoided, thereby achieving low-frequency (e.g., 1 Hz) drive.

Step 503, a second retention phase, in which a first gate drive signal at a first potential and a signal at a second potential are alternatively provided for each of the first gate lines, and providing the second gate drive signal for each of the second gate lines is stopped.

Correspondingly, in the second retention phase, the switch transistor connected to each of the first gate lines may be turned on and off alternately, and the drive transistors connected to the plurality of second gate lines may remain off. By the second retention phase, the problem that the switch transistor maintains a negative or positive voltage for a long time and the characteristic drift occurs may be avoided.

It should be noted that the signal writing phase, the first retention phase and the second retention phase may be performed within a frame scan time, and the signal writing phase, the first retention phase, and the second retention phase may be sequentially performed for each frame scan. In other words, every frame scan may refer to the driving method shown in FIG. 5.

It should also be noted that the sequence of the steps of the driving method for array substrate according to the embodiment of the present disclosure may be adjusted appropriately, and the steps may also be increased or decreased according to certain situations. For example, the above step 503 may be performed before step 502, i.e., after the signal writing phase, the second retention phase may be performed before the first retention phase. Or, the above step 502 or step 503 may be deleted according to certain situations, i.e., only the first retention phase or only the second retention phase is performed after the signal writing phase. Any methods which those skilled in the art may think in the technical scope disclosed by the present disclosure should be covered within the protection scope of the present disclosure, thus it will not be elaborated.

Exemplified by the array substrate shown in FIG. 4, and by a situation that both the drive transistor and the switch transistor are N-type transistors, the provided gate drive signal is a signal at a first potential, stopping providing the gate drive signal is equivalent to providing a signal at a second potential, and the first potential is high relative to the second potential, the driving principle of the array substrate according to the embodiment of the present disclosure is described as below:

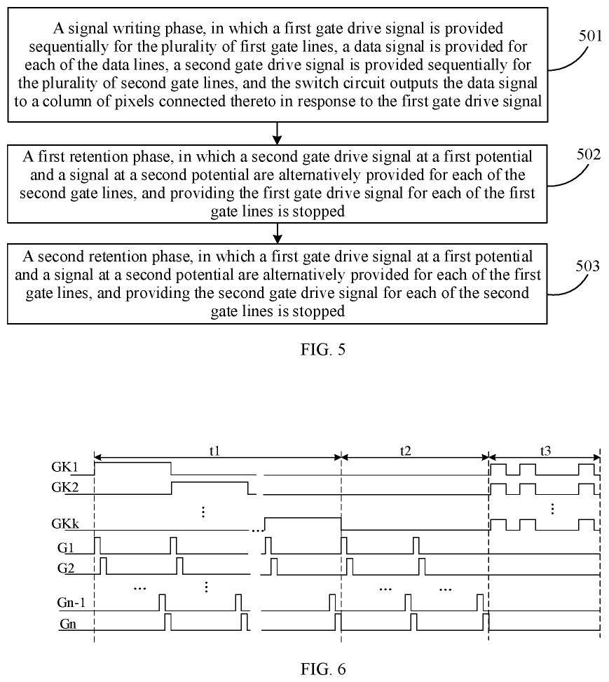

FIG. 6 is a timing diagram of outputting signals to each signal line according to an embodiment of the present disclosure. As shown in FIG. 6, in the signal writing phase t1, the first gate drive signal may be sequentially provided to the first to k^{th} first gate lines GK1 to GKk. In other words, when a first gate line GK is provided with a first gate drive signal at a first potential, a signal at a second potential is provided for all the first gate lines GK other than the 1^{st} first gate line GK. Correspondingly, m switch transistors K1 in the first region A1 to m switch transistors K1 in the k^{th} region Ak may be turned on sequentially, and m switch transistors K1 in the same region A may be turned on at the same time. The data lines S1 to Sm may output data signals to the drive transistor T1 connected to each switch transistor K1 through m switch transistors K1.

With reference to FIG. 6, within a duration of providing the first gate drive signal for a first gate line GK, the second gate drive signal may be sequentially provided for the 1^{st} to n^{th} second gate lines G1 to Gn. In other words, when a second gate line G1 is provided with a second gate drive signal at a first potential, the signal at the second potential is provided for all the second gate lines G other than the second gate line G. Correspondingly, the drive transistors T1 of n rows of pixels 10 disposed in one region A controlled by the first gate line GK may be turned on row by row, and the drive transistors T1 of m pixels 10 disposed in the same row may be turned on simultaneously. The data signal may output the data signal to pixel electrodes connected to the m drive transistors T1 through m drive transistors T1 turned on to charge the pixel electrodes, such that the liquid crystal molecules deflect, further causing the pixels to emit light.

Illustratively, taking a situation that the first gate drive signal at the first potential is provided for the 1^{st} first gate line GK1 as an example, a signal at a second potential is provided for the 2^{nd} first gate line GK2 to the k^{th} first gate line GKk. The m switch transistors K1 disposed in the first region A1 are all turned on, and the switch transistors K1 disposed in the second region A2 to the k^{th} region Ak are all turned off. Then, the data lines S1 to Sm may output the data signal to the drive transistor T1 of the n^{th} row and m^{th} column of pixels 10 disposed in the first region A1 by the m switch transistors K1 disposed in the first region A1.

And then, the second gate drive signal at the first potential is provided sequentially for the first second gate line G1 to the n^{th} second gate line Gn, such that the drive transistor T1 in the first row of pixels 10 to the drive transistor T1 the n^{th} row of pixels in each of the regions A are turned on row by row. For example, when the first second gate line G1 provides the second gate drive signal at the first potential, the drive transistors T1 in the m pixels 10 in the first row in each of the regions are turned on. Since the data lines S1 to Sm only output the data signal to the plurality of drive transistors T1 disposed in the first region A1, then the data signal is output to the pixel electrodes of the rows of pixels disposed in the first region A1 only through the drive transistor T1 that is turned on row by row in the first region A1, so as to charge the liquid crystal capacitor Clc and the storage capacitor Cst. Starting from the first row of pixels 10 disposed in the first region A1, n rows of pixels are charged sequentially row by row.

After the pixels in the first region A1 have been charged, the first gate drive signal at the first potential is provided for the 2^{nd} first gate line GK2 while sequentially providing the second gate drive signal at the first potential for the first second gate line G1 to the n^{th} second gate line Gn, so as to realize the row-by-row scanning for n rows of pixels in the second region A2. In this analogy, until the row-by-row scanning of n rows of pixels in the k^{th} region Ak is completed, a frame of picture is updated. This driving method may also be called region scanning.

In the first retention phase t2, a second gate drive signal at a first potential and a signal at a second potential are alternatively provided for each of the second gate lines in the first second gate line G1 to the n^{th} second gate line Gn, and providing the first gate drive signal at the first potential for the 1^{st} first gate line GK1 to the k^{th} first gate line GKk is stopped, i.e., a signal at the second potential is provided for the 1^{st} first gate line GK1 to the k^{th} first gate line GKk. Correspondingly, the plurality of switch transistors K1 included in the array substrate 100 are all turned off, and each of the drive transistors T1 of each row of pixels 10 in each of the regions A is turned on and off alternately. Since the pixels may only be driven to emit light when the first gate drive signal and the second gate drive signal are provided, the drive transistors T1 will not charge the pixels in this first retention phase t2.

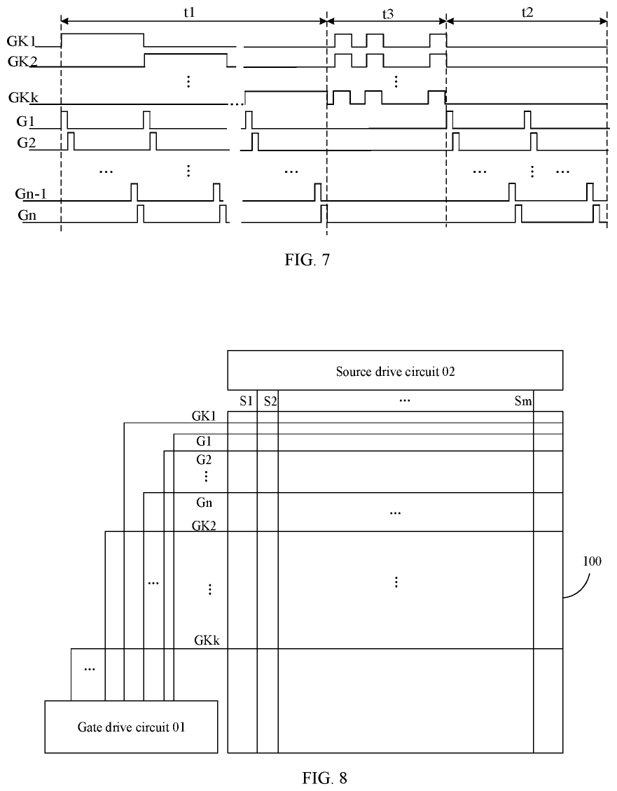

With reference to FIGS. 6 and 7, the periods during which the first gate drive signal at the first potential is provided for each of the first gate lines GK may not overlap each other. And, in the first retention phase t2, the duration of providing the first gate drive signal at the first potential for each of the first gate lines GK may be less than the duration of providing the signal at the second potential for each of the first gate lines GK.

By the driving method of the first retention phase t2, the problem that the drive transistor maintains negative voltage for a long time and the characteristic drift occurs may be effectively improved.

In the second retention phase t3, the first gate drive signal at the first potential and the signal at the second potential are alternatively provided for each of the first gate lines GK, and providing the second gate drive signal for the first second gate line G1 to the n^{th} second gate line Gn is stopped, i.e., a signal at the second potential is provided for each of the second gate lines G. Correspondingly, each of the switch transistors K1 disposed in each of the regions A is turned on and off alternately, and the drive transistor T1 of each row of pixels 10 disposed in each of the regions A remains off. Similarly, since the pixels may only be driven to emit light when the first gate drive signal and the second gate drive signal are provided, the drive transistors T1 will also not charge the pixels in this second retention phase t3.

With reference to FIG. 6, the periods during which the second gate drive signal at the first potential is provided for each of the second gate lines G may not be the same. And, in the second retention phase t3, the duration of providing the second gate drive signal at the first potential for each of the second gate lines G may be equal or similar to the duration of providing the signal at the second potential for each of the second gate lines G.

By the second retention phase t3, the problem that the transistor maintains negative voltage for a long time and the characteristic drift occurs may be effectively improved.

It should be noted that the order of execution of the first retention phase t2 and the second retention phase t3 is not limited. For example, as shown in FIG. 6, the first retention phase t2 is executed first and then the second retention phase t3 is executed. Or, as shown in FIG. 7, after the signal writing phase t1, the second retention phase t3 is executed first and then the first retention phase t2 is executed.

It should also be noted that, in combination with FIGS. 6 and 7, the first retention phase t2 and the second retention phase t3 may be collectively referred to as a retention phase, i.e., the update for each frame of picture includes two phases of the signal writing phase and the retention phase. And, the duration of providing the first gate drive signal at the first potential for the first gate line Gk is the time for charging the pixels disposed in one region A. The duration of providing the second gate drive signal at the first potential for the second gate line G is the time for charging one row of pixels.

In summary, the embodiment of the present disclosure provides a method for driving an array substrate. Since he switch circuit may output the data signal to a column of pixels connected thereto in response to the gate drive signal provided by the first gate line, only one second gate line may be arranged to be connected to the plurality of rows of pixels in different regions. The driving method is intended to flexibly control the signals provided by each signal line, which may ensure the row-by-row reliable scanning of the plurality of rows of pixels. Thus, under the premise of ensuring reliability in driving, the number of gate lines required to be arranged is effectively reduced, which facilitates the narrow-bezel design.

FIG. 8 is a schematic structural diagram of a display module according to an embodiment of the present disclosure. As shown in FIG. 8, the display module may include a gate drive circuit 01, a source drive circuit 02 and the array substrate as described in above embodiments. For example, the array substrate 100 shown in any one of FIG. 2 to FIG. 4 may be included.

The gate drive circuit 01 may be connected to the first gate line GK and the second gate line Gin the array substrate 100, and the gate drive circuit 01 is configured to provide the first gate drive signal for the first gate line GK and the second gate drive signal for the second gate line G. The source drive circuit 02 may be connected to the data line S in the array substrate 100, and the source drive circuit 02 may be used to provide the data signal for the data line S.

For example, with reference to FIG. 8, the illustrated array substrate 100 includes k first gate lines GK1 to GKk, n second gate lines G1 to Gn, and m data lines S1 to Sm. Then, with reference to FIG. 8, the gate drive circuit 01 may be connected to the k first gate lines GK1 to GKk and the n second gate lines G1 to Gn, and the source drive circuit 02 may be connected to the m data lines S1 to Sm.

Optionally, the gate drive circuit 01 may include a first gate drive chip and a second gate drive chip. The first gate drive chip may be connected to the first gate line GK, and the first gate drive chip is configured to provide the first gate drive signal for the first gate line GK. The second gate drive chip may be connected to the second gate line G, and the second gate drive chip is configured to provide the second gate drive signal for the second gate line G. The first gate drive chip may also be called a primary gate drive circuit, and the second gate drive chip may also be called a secondary gate drive circuit.

Optionally, an embodiment of the present disclosure further provides a display device. The display device may include the display module shown in FIG. 8, and a housing configured to package the display module.

The display device may be an LCD display device, an electronic paper, an OLED display device, an AMOLED display device, an electrowetting display device, a mobile phone, a television, a monitor, a notebook computer, a digital photo frame, a navigator, or other products or components having the display function.

It will be apparent to those skilled in the art that the specific operation of the array substrate and each circuit described above may be referred to the corresponding process in the aforementioned method embodiments for the sake of convenience and conciseness of the description and will not be described again here.

Described above are only optional embodiments of the present disclosure, but are not intended to limit the present disclosure, Any modifications, equivalent substitutions, improvements and the like made within the spirit and principles of the present disclosure are all intended to be concluded in the protection scope of the present disclosure.

1. An array substrate, being provided with a plurality of regions, the array substrate comprising a plurality of data lines, a plurality of first gate lines, a plurality of second gate lines, and a plurality of pixels and a plurality of switch circuits that are disposed in each of the regions, at least one of the switch circuits being arranged in each of the regions, and n rows of the pixels are arranged in each of the regions, n being a positive integer greater than 1; wherein
each of the first gate lines is connected to the plurality of switch circuits of one of the regions, the plurality of switch circuits connected to each of the first gate lines are disposed in a different region from the switch circuits connected to any other first gate lines, and each of the first gate lines is configured to provide a first gate drive signal for the switch circuit connected thereto;
each of the data lines is connected to the plurality of switch circuits disposed in a same column, and each of the data lines is configured to provide a data signal for the switch circuit connected thereto;
each of the switch circuits comprises a switch transistor, wherein a gate of the switch transistor is connected to a first gate line, a first electrode of the switch transistor is connected to a data line, a second electrode of the switch transistor is connected to a column of pixels in the region where the switch circuit is disposed, and each of the switch circuits is configured to output the data signal to a column of pixels connected thereto in response to the first gate drive signal; and
each of the second gate lines is connected to a plurality of rows of the pixels, and at least two rows of the pixels connected to each of the second gate lines are disposed in different regions, and each of the second gate lines is configured to provide a second gate drive signal for the plurality of rows of the pixels connected thereto.

2. (canceled)

3. The array substrate according to claim 1, wherein the plurality of rows of the pixels connected to each of the second gate lines are disposed in different regions, the plurality of pixels connected to each of the second gate lines are disposed in a different row from the pixels connected to any other second gate lines.

4. The array substrate according to claim 3, wherein the array substrate comprises n second gate lines;
an i^{th} second gate line is connected to an i^{th} row of the pixels of each of the regions, i being a positive integer less than or equal to n.

5. The array substrate according to claim 1, wherein a number of switch circuit arranged in each of the regions is equal to the number of columns of the pixels included in the regions, and the pixels connected to a different switch circuit in each of the regions are disposed in different columns.

6. The array substrate according to claim 1, wherein each of the pixels comprises a drive transistor and a light emitting element; wherein
a second electrode of the switch transistor is connected to a first electrode of the drive transistor;
a gate of the drive transistor is connected to a second gate line, and a second electrode of the drive transistor is connected to the light emitting element.

7. The array substrate according to claim 1, wherein each of the switch circuits is disposed in a non-display zone of one of the pixels.

8. The array substrate according to claim 1, wherein each of the switch circuits is disposed in a region between two adjacent pixels.

9. The array substrate according to claim 1, wherein each of the first gate lines comprises a first sub-line segment and a second sub-line segment connected to the first sub-line segment, the first sub-line segment being connected to the plurality of switch circuits; each of the second gate lines comprises a plurality of third sub-line segments and a fourth sub-line segment connected to each of the third sub-line segments, each of the third sub-line segments being connected to one row of the pixels;
wherein each first sub-line segment is parallel to each of the third sub-line segments, each second sub-line segment is parallel to each fourth sub-line segment, and an extending direction of each first sub-line segment intersects with an extending direction of any second sub-line segment.

10. The array substrate according to claim 9, wherein each first sub-line segment and each of the third sub-line segments are perpendicular to an extending direction of the data line; and
each second sub-line segment and each fourth sub-line segment are parallel to the extending direction of the data line.

11. The array substrate according to claim 4, wherein the array substrate is provided with k regions, and the array substrate comprises k the first gate lines, k being a positive integer greater than 1; a number of switch circuits arranged in each of the regions is equal to the number of columns of the pixels included in the region, the pixels connected to different switch circuits in each of the regions are disposed in different columns, and each of the switch circuits is disposed in the non-display zone of one of the pixels;
each of the pixels comprises a drive transistor and a light emitting element, and the switch circuit comprise a switch transistor;
a gate of the switch transistor is connected to the first gate line, a first electrode of the switch transistor is connected to the data line, and a second electrode of the switch transistor is connected to a first electrode of the drive transistor; and
a gate of the drive transistor is connected to the second gate line, and a second electrode of the drive transistor is connected to the light emitting element;
wherein each of the first gate lines comprises a first sub-line segment and a second sub-line segment connected to the first sub-line segment, and the first sub-line segment is connected to the plurality of switch circuits; each of the second gate lines comprises a third sub-line segment and a plurality of fourth sub-line segments connected to the third sub-line segment, and each of the fourth sub-line segments is connected to one row of the pixels; and
each first sub-line segment and each third sub-line segment are parallel to each other and parallel to the extending direction of the data line, and each second sub-line segment and each of the fourth sub-line segments are parallel to each other and perpendicular to the extending direction of the data line.

12. A method for driving an array substrate, the array substrate being provided with a plurality of regions, the array substrate comprising a plurality of data lines, a plurality of first gate lines, a plurality of second gate lines, and a plurality of pixels and a plurality of switch circuits that are disposed in each of the regions, at least one of the switch circuits being arranged in each of the regions, and n rows of the pixels are arranged in each of the regions, n being a positive integer greater than 1; wherein each of the first gate lines is connected to the plurality of switch circuits of one of the regions, the plurality of switch circuits connected to each of the first gate lines are disposed in a different region from the switch circuits connected to any other first gate lines, each of the data lines is connected to the plurality of switch circuits disposed in a same column, each of the switch circuits comprises a switch transistor, wherein a gate of the switch transistor is connected to a first gate line, a first electrode of the switch transistor is connected to a data line, a second electrode of the switch transistor is connected to a column of pixels in the region where the switch circuit is disposed, each of the second gate lines is connected to a plurality of rows of the pixels, and at least two rows of the pixels connected to each of the second gate lines are disposed in different regions;
the method comprising:
a signal writing phase: providing the first gate drive signal sequentially for the plurality of first gate lines, providing the data signal for each of the data lines, and providing the second gate drive signal sequentially for the plurality of second gate lines, the plurality of switch circuit outputting the data signal to a column of pixels connected thereto in response to the first gate drive signal;
wherein within a duration of providing the first gate drive signal for each of the first gate lines, the second gate drive signal is provided sequentially for the plurality of second gate lines.

13. The method according to claim 12, wherein after the signal writing phase, the method further comprises:
a first retention phase: alternatively providing the second gate drive signal at a first potential and a signal at a second potential for each of the second gate lines, and stopping providing the first gate drive signal for each of the first gate lines.

14. The method according to claim 12, wherein after the signal writing phase, the method further comprises:
a second retention phase: alternatively providing the first gate drive signal at the first potential and the signal at the second potential for each of the first gate lines, and stopping providing the second gate drive signal for each of the second gate lines.

15. The method according to claim 12, wherein after the signal writing phase, the method further comprises:
a first retention phase: alternatively providing the second gate drive signal at the first potential and the signal at the second potential for each of the second gate lines, and stopping providing the first gate drive signal for each of the first gate lines;
a second retention phase: alternatively providing the first gate drive signal at the first potential and the signal at the second potential for each of the first gate lines, and stopping providing the second gate drive signal for each of the second gate lines.

16. A display module, comprising: a gate drive circuit, a source drive circuit, and an array substrate; wherein the array substrate is provided with a plurality of regions, and the array substrate comprises a plurality of data lines, a plurality of first gate lines, a plurality of second gate lines, and a plurality of pixels and a plurality of switch circuits that are disposed in each of the regions, at least one of the switch circuits being arranged in each of the regions, and n rows of the pixels are arranged in each of the regions, n being a positive integer greater than 1;
wherein each of the first gate lines is connected to the plurality of switch circuits in one of the regions, the plurality of switch circuits connected to each of the first gate lines are disposed in a different region from the switch circuits connected to any other first gate lines, and configured to provide a first gate drive signal for a switch circuit connected thereto; each of the data lines is connected to the plurality of switch circuits disposed in a same column, configured to provide a data signal for a switch circuit connected thereto; each of the switch circuits comprises a switch transistor, wherein a gate of the switch transistor is connected to a first gate line, a first electrode of the switch transistor is connected to a data line, a second electrode of the switch transistor is connected to a column of pixels in a region where the switch circuit is disposed, configured to output the data signal to a column of pixels connected thereto in response to the first gate drive signal; each of the second gate lines is connected to a plurality of rows of pixels, at least two rows of the pixels connected to each of the second gate lines are disposed in different regions, and each of the second gate lines is configured to provide the second gate drive signal for the plurality of rows of the pixels connected thereto;
the gate drive circuit is connected to the first gate lines and the second gate lines in the array substrate, and configured to provide the first gate drive signal for the first gate lines and provide the second gate drive signal for the second gate lines; and
the source drive circuit is connected to the data lines in the array substrate, and configured to provide the date signal for the data lines.

17. The display module according to claim 16, wherein the gate drive circuit comprises a first gate drive chip and a second gate drive chip; wherein
the first gate drive chip is connected to the first gate line, and configured to provide the first gate drive signal for the first gate line; and
the second gate drive chip is connected to the second gate line, and configured to provide the second gate drive signal for the second gate line.

18. The display module according to claim 16, wherein each of the first gate lines is connected to the plurality of switch circuits of one of the regions, and the switch circuit connected to each of the first gate lines are disposed in different regions.

19. The display module of claim 16, wherein a plurality of rows of the pixels connected to each of the second gate lines are disposed in different regions.

20. A display device, comprising the display module of claim 16, and a housing configured to package the display module.

21. The array substrate according to claim 1, each of the pixels emits light when the second gate line which is connected provides the second gate drive signal for the pixel and the switch circuit which is connected outputs the data signal to the pixel in response to the first gate drive signal.
